(19) United States
(12) Patent Application Publication
(10) Pub. No.: US 2008/0144006 A1
(43) Pub. Date: Jun. 19, 2008

(54) Method for Measuring Topographic Structures on Devices

(75) Inventors: Michael Stelzl, Mainz (DE); Volker Seidemann, Berlin (DE); Jürgen Leib, Freising (DE); Ha-Duong Ngo, Berlin (DE)

Correspondence Address: DEMONT & BREYER, LLC, 100 COMMONS WAY, Ste. 250, HOLMDEL, NJ, 07733, US

(73) Assignee: SCHOTT AG, Mainz (DE)

(21) Appl. No.: 11/569,242

(22) PCT Filed: May 13, 2005
(86) PCT No.: PCT/EP2005/005281

§ 371 Date: Feb. 21, 2008

(30) Foreign Application Priority Data
May 17, 2004 (DE) 10 2004 024 785.4

(51) Int. Cl. G01J 3/00; G01B 11/28; G01N 21/55

(52) U.S. Cl. 356/51; 356/630; 356/445

(57) ABSTRACT

In order to be able to measure topographies on wafers or devices in a fashion free from destruction, the invention provides a method for measuring three-dimensional topographic structures (22) on wafers (2) or devices in which with the aid of a confocal microscope (1) at least one fluorescing topographic structure (22) is scanned with excitation light, and the fluorescence light emitted from the focal point (17) in the focal plane (19) of the objective (15) and excited by the excitation light is detected, and measured data are obtained from the position of the focal point (17) and the detected fluorescence signal.

The invention relates in general to the field of microscopy, in particular the measurement of topographic structures on devices by means of confocal microscopy.

There is a need in the field of semiconductor manufacturing for measuring devices that measure surfaces of the device in order to control production steps in two or three dimensions. It is also desirable, inter alia, to be able to measure and check the topography of applied varnish layers such as, for example, photovarnish layers or insulation layers.

Suitable inter alia for this purpose are electron microscopes or white light interferometers. Although electron microscopes deliver very good images, they have the disadvantage that the wafer or the device must be destroyed.

White light interferometers also permit high precision measurements. However, these units have an unfavorable numerical aperture, and so no light falls back into the optics from surfaces with steep angles, and these surfaces therefore cannot be detected. Again, varnish layer thicknesses cannot be measured.

In order to be able to measure photoresist patterns on a sample, it is known from JP 10019532 A2 to irradiate the sample with UV light through a dichroic mirror and an objective, and to use an image recording device to record the excited fluorescence light, which is emitted by the photoresist on the sample and is reflected by the dichroic mirror after passage through the objective. A fluorescence image of the photoresist pattern is obtained in this way. However, with this set up only the lateral distribution of the photoresist is detected.

A similar setup is furthermore known from JP 60257136 A2. In addition to the fluorescence signal, the signal from the surface lying below the fluorescing film is detected. The layer thickness of the reflecting film can be determined from a determination of the intensity ratio of the fluorescence light and the reflected light. However, such an apparatus is suitable only for measuring relatively flat topographies, since the depth of field of a conventional microscope is limited.

A broadband, catadioptric UV microscope is known from U.S. Pat. No. 6,133,576 A. Moreover, a method for checking wafer surfaces is described in which the surface to be tested is detected in three dimensions, scanning being carried out simultaneously with light of various wavelengths. The microscope is designed such that the focal planes of the light of various wavelengths lie at different depths such that in each case layers of different depth are recorded with the aid of the light of different wavelengths. The respective images relating to different wavelengths can then be combined to form a three-dimensional image of the sample.

This method has, however, the disadvantage that it is only poorly suited to carrying out fluorescence recordings. The fluorescence signal is known to have a greater wavelength than the excitation light. In the case of a broadband illumination such as is used in accordance with the method described in U.S. Pat. No. 6,133,576 A, the wavelength region of the fluorescence signal then comes to overlap with that of the excitation light, or fluorescence light of the same wavelength is generated for various wavelengths of the excitation light. In both instances, the detected light can no longer be assigned to the fluorescence or the reflection, nor to the scattering of the excitation light in the individual layers. Consequently, the depth information is lost and so a three-dimensional reconstruction of fluorescing structures is defective.

The invention is therefore based on the object of enabling an accurate three-dimensional measurement of fluorescing structures on wafers or devices.

This object is already achieved in a most surprisingly simple way by a method as claimed in claim 1. Advantageous refinements and developments of the invention are specified in the dependent claims.

Consequently, the invention provides a method for measuring three-dimensional topographic structures on wafers or devices, in which with the aid of a confocal microscope at least one fluorescing topographic structure is scanned with excitation light, and the fluorescence light emitted from the focal point in the focal plane of the objective and excited by the excitation light is detected, and measured data are obtained from the position of the focal point and the detected fluorescence signal. The method according to the invention is generally suitable for checking wafers and devices with topographies, that is to say, for example, for checking wafers or devices with micromechanical, electronic, optoelectronic and/or optical devices.

The invention consequently makes use of the possibility of confocal microscopy in order to measure topography. By contrast with the method described in U.S. Pat. No. 6,133,576 A, in the case of confocal microscopy it is not broadband light, but monochromatic or at least substantially monochromatic light that is used for measuring the topography of a wafer or device. In conjunction with confocal microscopy, this enables the unique assignment of the detected fluorescence light to the excitation light and the location of emission, specifically the focal point of the excitation light, and thus a highly accurate measurement of fluorescing topographic structures in or on the wafer or device to be examined. Thus, in addition to the surface of the structures, the method according to the invention can also measure the volume of these structures. By contrast with electron microscopic analysis, confocal microscopy particularly also enables the nondestructive measurement of the samples. In addition, as against white light interferometry apparatuses, confocal microscopes have a more favorable numerical aperture.

The method is suitable for examining many types of three-dimensional topographic structures such as, for example, varnish layers, varnish remnants after photostructuring of a photoresist, etched vias or dicing streets that have been inserted in fluorescing material or filled with fluorescing material. A further advantageous application is the measurement of micromechanical devices on wafers such as, for example, microelectromechanical (MEMS) or microoptoelectromechanical (MOEMS) structures.

It is, however, advantageous also to detect the reflected and/or scattered excitation light. It is thereby possible as well, inter alia, also to obtain data of structures of the wafer or device that are not fluorescing, or are so only weakly. The detection of scattered excitation light from fluorescing or transparent structures also permits, for example, conclusions relating to their inner nature such as, for example, to instances of turbidity that may be present.

Depending on the application of the desired information, it can suffice to measure along a line or curve, or to record measuring points on a section through the structure to be checked. In accordance with one advantageous embodiment of the invention, however, it is also possible, in particular to obtain measured data from three-dimensionally distributed measuring points. These measuring points can be distributed such that one or more structures to be measured, subregions or the complete surface of the wafer or device are detected in their entirety and three-dimensional structure.

One preferred embodiment of the invention provides, in particular, to calculate a three-dimensional reconstruction of the topographic structure from the intensity values of the fluorescence light and assigned position values of the focal point. This can then be displayed, for example, on a display screen for checking and analysis.

One advantageous development of this embodiment provides, furthermore, that in order to calculate the three-dimensional structure additional use is made of measured data with intensity values of reflected excitation light and assigned position values of the focal point. By way of example, it is possible by means of such a combination of a reflection channel and a fluorescence channel easily to distinguish fluorescing varnishes on the wafer or device to be examined from materials of the substrates such as, for example, silicon or copper.

The measured values obtained according to the invention can also be used, for example, to determine the layer thickness of the topographic structure to be checked. When calculating a three-dimensional reconstruction or a two dimensional section through the structure, it is possible in addition to the average layer thickness also to establish deviations from the mean value of the layer thickness. For example, the variants and the minimum and maximum values of the layer thickness can provide information on the quality and possible defects of the topographic structure or the wafer, or of the device.

It is particularly advantageous to scan the topographic structure to be measured along the focal plane of the microscope in layerwise fashion. To this end, measuring points from a single layer or, in particular, also from a number of layers lying one above another can be measured depending on the information desired. An option in this case is that the focal plane is displaced along the optical axis of the objective of the confocal microscope relative to the topographic structure for the purpose of scanning the layers. The displacement of the focal plane can be performed in a simple way by displacing the wafer or device. Furthermore, it is expedient to provide a scanning unit of the microscope for the layerwise scanning of the structure. Such a scanning unit can, for example, comprise scanning mirrors, a Nipkow disk and/or an acoustooptic deflector that move one or more light beams or their focal points along a layer.

All types of confocal microscopes are suitable for the method according to the invention. A laser scanning microscope (LSM), in particular, has proved to be advantageous for the purposes of the invention, since the use of laser light as excitation light enables rapid scanning in conjunction with high spatial resolution.

Many substances can be excited to fluorescence particularly effectively by means of ultraviolet light. Consequently, it is favorable to use ultraviolet light as excitation light. In particular, in this case light with wavelengths of 480 nm, 458 nm or 514 nm is suitable, it being possible to produce such light with the aid of laser light sources.

In general, organic materials, in particular polymers, are particularly suitable for fluorescence excitation. Consequently, structures can be measured particularly advantageously with the aid of organic substances. In accordance with one embodiment of the invention, it is therefore provided that a three-dimensional topographic structure is measured that has at least one of the substances comprising photoresist, BCB (benzocyclobuten), such as cycloten, and SUB or other photostructurable epoxies. In the field of electronics and optoelectronics, these surfaces are customary and constitute organic materials used in many ways.

By way of example, the method according to the invention can be used advantageously to measure and check etched vias or dicing streets in the wafer or device. In this case, for example, the substrate material itself can fluoresce and/or the via or the dicing street can be filled up with fluorescing material.

A particular problem in checking topographic structures on wafers or devices is the measurement of structures that cannot be detected in their entirety from one direction of view, because they have covered regions. Such structures cannot be measured without being destroyed or touched with the aid of previously customary methods. In accordance with a further aspect of the invention, a method is therefore also provided with the aid of which it is possible to measure such structures.

Consequently, according to the invention a method is also provided for measuring three-dimensional topographic structures on wafers or devices in which with the aid of a confocal microscope at least one topographic structure is scanned with light, and the light returning from the focal point in the focal plane of the objective is detected, and measured data are obtained from the position of the focal point and the detected returning light, regions of the structure being detected whose surface runs along a direction parallel to the optical axis, or that are even shaded when light is incident parallel to the optical axis of the microscope.

This method can also be combined with the above described embodiments of the method according to the invention for measuring topographic structures by means of confocal fluorescence light microscopy.

It has emerged surprisingly that the large numerical aperture of a confocal microscope allows such structures with extremely steep surfaces or even shaded regions to be imaged and measured. In this case, the beams of the illuminating light that are incident at large angles can also still illuminate such regions as are no longer reached, owing to shading effects, by light incident along or parallel to the optical axis of the objective. For example, it is possible thus to measure regions of the structure that in the case of light incident in a fashion parallel to the optical axis of the objective are shaded or covered by another region of the structure, of the wafer or of the device.

The measured data obtained for the purpose of measurement with the aid of the method according to the invention can be produced from light retroreflected at the surface of the structure, and/or from diffusely backscattered light and/or from fluorescence light produced at the focal point.

It is particularly well possible to use the invention to detect very steep surfaces with a large angle of inclination to the wafer surface in the case of which the excitation light strikes with a grazing incidence or at a flat angle when these surfaces have an adequate roughness. The detected signal is then primarily to be ascribed to diffusely backscattered light.

Shaded regions that can be measured according to the invention can, for example, enclose instances of back etching such as repeatedly occur with etched structures.

The invention is explained in more detail below with the aid of exemplary embodiments and with reference to the drawings, identical and similar elements being provided with the same reference symbols, and it being possible to combine the features of various exemplary embodiments with one another.

In the drawing:

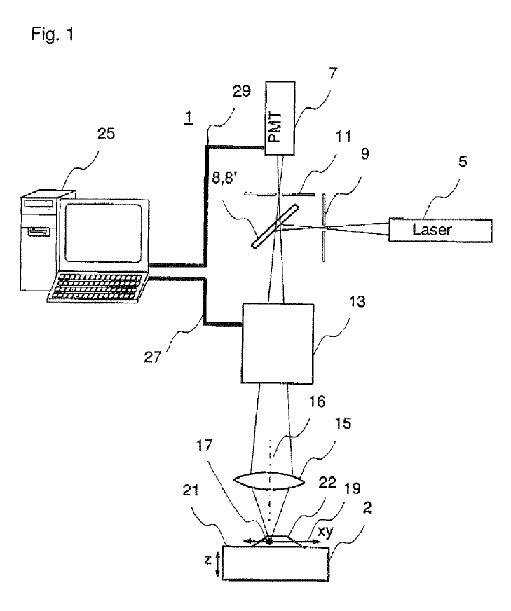

FIG. 1 shows a schematic of a confocal microscope for carrying out the method according to the invention,

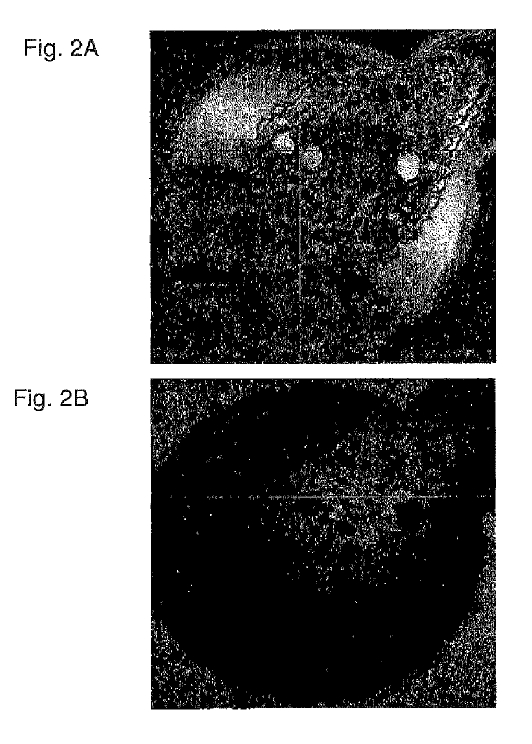

FIG. 2A shows a microscope picture of the reflection signal of a resist structure on a wafer,

FIG. 2B shows a microscope picture of the fluorescence signal of the resist structure,

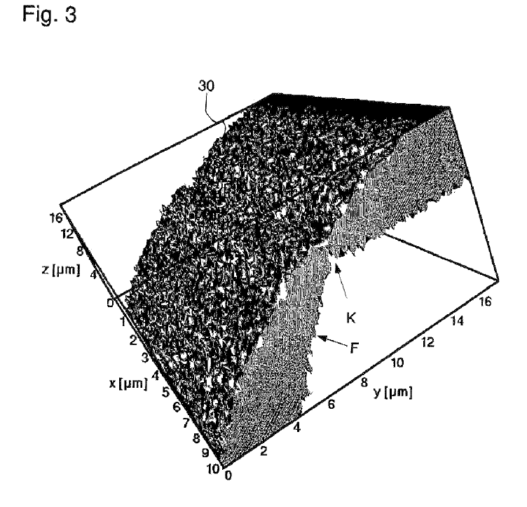

FIG. 3 shows a three-dimensional reconstruction of a further resist structure,

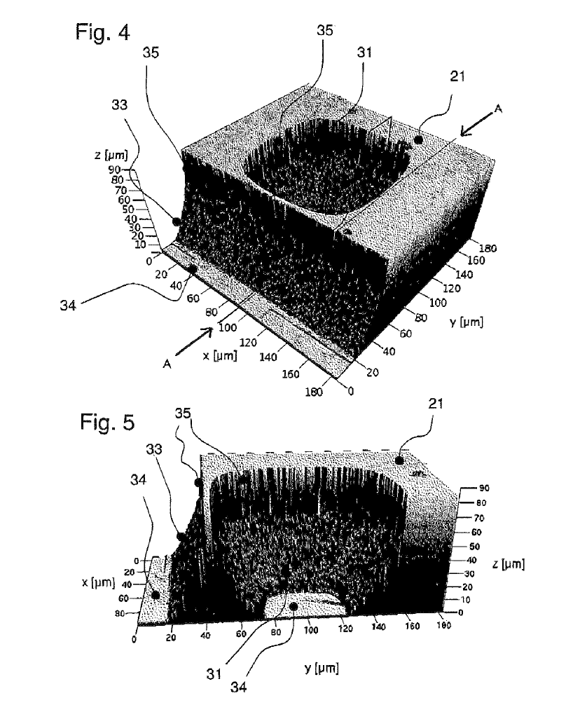

FIG. 4 shows a three-dimensional reconstruction of a region of a wafer surface,

FIG. 5 shows a view of the three-dimensional reconstruction shown in FIG. 4 that is cut open along a section in the yz plane along the line A-A,

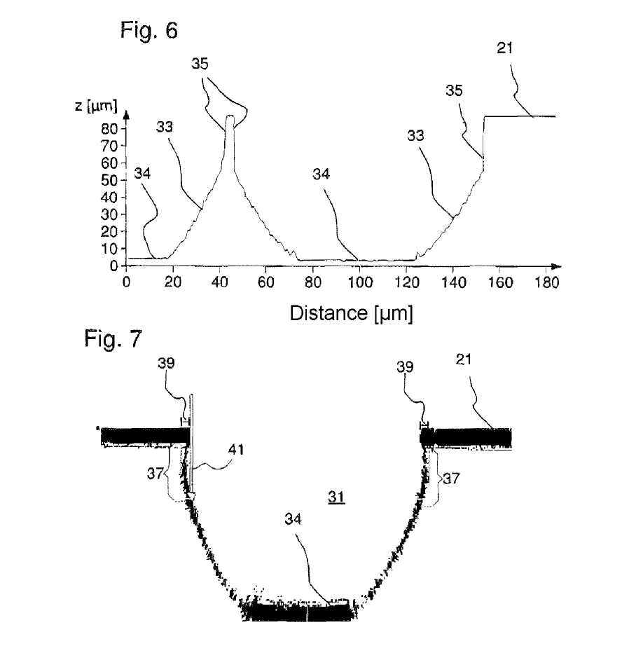

FIG. 6 shows measured height values along the section along the line A-A in FIG. 4, and

FIG. 7 shows measured values along a section through a wafer with an etched via.

FIG. 1 is a schematic of a confocal LSM, denoted as a whole by the reference symbol 1, in a way suitable for carrying out the method according to the invention for measuring three-dimensional topographic structures on wafers or devices. Such a confocal microscope 1 typically comprises a laser 5 as illumination source. Ultraviolet light sources such as, for example, UV-lasers, are particularly suitable in this case for exciting fluorescence in organic materials.

A photomultiplier tube 7 is provided for detecting the fluorescence light excited by the laser light. The light from the laser 5 is coupled onto the optical axis of the microscope 1 via a dichroic mirror 8. In order in addition to the fluorescence light also to detect reflected or scattered excitation light, the dichroic mirror 8 can be replaced by a beam splitter 8′ that is transparent to the light coming from the sample.

The confocal microscope 1 is used to scan a fluorescing topographic structure 22 with the aid of the excitation light, and to detect the fluorescence light emitted from the focal point 17 in the focal plane 19 of the objective and excited by the excitation light. Measured data are then obtained from the position of the focal point 19 and the detected fluorescence signal, and recorded.

Provided in the beam path of the microscope so as to yield a confocal configuration are two confocally arranged diaphragms 9 and 11 for the laser light, or the light reflected from the sample to be examined, or emitted.

Illustrated as sample in the case of the exemplary embodiment shown in FIG. 1 is a wafer 2 on whose surface 21 the fluorescing topographic structure 22 to be measured is arranged. The structure 22 and, optionally, the wafer surface 21 are scanned in layerwise fashion with the confocal microscope 1 along the focal plane 19 in the xy direction. The scanning of the layers is performed in this case by scanning the excitation light by means of a scanning unit 13. The scanning of the layers can be performed, for example, by means of a moving scanning mirror, a rotating Nipkow disk or an acoustooptic deflector as devices of the scanning unit 13.

A number of layers lying one above another in the z direction can be recorded such that measured data are obtained from three-dimensionally distributed measuring points with the result that it is possible to calculate a three-dimensional reconstruction of the structure 22 and of the wafer surface.

In order to record or scan the layers sequentially, the focal plane 19 is displaced relative to the topographic structure 22 along the optical axis 16 of the objective 15 of the microscope 1, the displacement of the focal plane 19 being performed by displacing the wafer 2 along the z direction.

Finally, a computer 25 uses the intensity values of the fluorescence light and assigned known position values of the focal point to calculate a three-dimensional reconstruction of the topographic structure 22. To this end, the computer is connected to the scanning unit 13 and the photomultiplier tube 7 via lines 27, 29 such that the intensity values detected by the photomultiplier tube 7 can be transmitted to the computer, and the scanning unit, and therefore the position of the focal point 17 in the focal plane 19, can be controlled.

In addition, it is also still possible to use measured data with intensity values of reflected excitation light and assigned position values of the focal point 19 to calculate the three-dimensional structure. It is possible to this end, for example, to scan the layers sequentially while detecting fluorescence light and reflected excitation light. Likewise, in a configuration deviating from FIG. 1 fluorescence light and reflected excitation light can also be detected simultaneously by means of an additional beam splitter and detector.

Pictures of a resist structure on a wafer that were taken using a confocal microscope are illustrated in FIGS. 2A and 2B. The pictures respectively illustrate the measured values from a two-dimensional layer along the focal plane of the objective. Here, FIG. 2A shows a microscope picture of the reflection signal of the resist structure, and FIG. 2B shows a microscope picture of the fluorescence signal of the same resist structure. Fluorescing resists of substrate materials such as silicon or copper can easily be distinguished by combining such pictures, or generally a combination of a reflection channel and a fluorescence channel. Remaining resist residues for example may in this way be made visible in structures. For example therefore there are still resist residues remaining after photostructuring in the circular part, free from resist as such, in the case of the resist structure illustrated in FIGS. 2A and 2B.

FIG. 3 shows a three-dimensional reconstruction of a topographic structure on a wafer. The structure is a part of a varnish layer 30 that has been applied to a structured surface of the wafer. The structuring of the wafer is such that the latter has a depression with obliquely falling flanks. Such structures are present, for example, in the case of etched vias, or of etched or ground dicing streets. The section of the varnish layer 30 that is illustrated in FIG. 3 shows a region that runs away over the top edge of the depression. The edge of the depression is designated by K, the obliquely falling flank by F.

The measured values for the three-dimensional reconstruction of varnish layer 30 were obtained by scanning the varnish layer 30 and detecting the fluorescence light emitted from the focal point of the objective and excited by the excitation light. The measuring points for determining the measured data are distributed in this case in three dimensions, the measured values having been recorded by layerwise scanning of layers lying one above another along the focal plane.

Since it is essentially only the resist that fluoresces under the action of ultraviolet light, the wafer material can be well distinguished from the varnish layer. Consequently, as FIG. 3 shows, it is possible to calculate a correct reconstruction of the varnish layer 30. The material of the substrate, or of the wafer, is not evident in the reconstruction.

The measured varnish layer 30 of this exemplary embodiment is a BCB insulation layer on a wafer. Similarly good results in the three-dimensional reconstruction can likewise also be achieved with the aid of other organic materials that are used in semiconductor manufacturing such as, for example, photoresist or a photostructurable epoxy, for example SU8.

BCB exhibits maximum absorption in the ultraviolet region at 335 nm wavelength. For many other organic materials, however, excitation light with wavelengths of 480 nm, 458 nm or 514 nm are also suitable. The maximum intensity of the emission of fluorescence light from BCB is at 390 nm wavelength.

In the case of structured wafer surfaces as in this example, varnish layers can in many instances not be applied by spin coating, since otherwise regions free of varnish form on the structures under some circumstances. Consequently, closed varnish layers are frequently applied by being sprayed onto such structured surfaces. However, even when varnishes are sprayed on thinner varnish layers can occur at edges. This effect is also to be seen at the edge K of the depression of the exemplary embodiment shown in FIG. 3. The varnish layer 30 exhibits a striking waist at this point. Here the method according to the invention assists, inter alia, in checking whether the varnish layer thickness still suffices to insulate conducting layers applied to this varnish layer from the wafer.

A further possibility of use for the method according to the invention is the three-dimensional reconstruction of micromechanical devices as constituents of a wafer or device. These can, for example, be produced from the wafer material, or be mounted thereon. One possibility for producing micromechanical devices consists in photostructuring plastic layers made from suitable plastics. Photostructurable epoxies, in particular, SU8, are suitable examples for this purpose. Such MEMS or MOEMS devices can be effectively measured and reconstructed using the method according to the invention by recording the fluorescence signal.

A three-dimensional reconstruction of a region of a wafer surface 21 is illustrated in FIG. 4. In this case, the wafer lies in the xy plane in the coordinate system selected in FIG. 4. FIG. 5 shows a view, cut open in the yz plane along the line A-A, of the reconstruction illustrated in FIG. 4. Moreover, FIG. 6 shows a graph with height values measured along the section.

The region of the wafer surface 21 that is illustrated in FIGS. 4 and 5 has a depression 31 and a trench 33, only half the trench 33 being illustrated. The depression 31 is an etched via hole, and the trench 33 is a dicing street along which the individual dies can be separated. The structures 31, 33 were both respectively etched, starting from the side 21 of the wafer, up to an etching stop layer. The etching stop layer is to be seen in both structures 31, 33 as, in each case, a flat bottom region 34 of the via 31 and the trench 33.

Both structures can be produced, for example, by etching. The structures 31, 33 have extremely steep surfaces with reference to the xy plane, in which the wafer lies, the regions 35 even lying perpendicular to the xy plane, or parallel to the optical axis of the microscope, which lie in the z direction.

The measured values of the topography of the wafer surface that are illustrated in FIGS. 4 to 6 were obtained according to the invention by using a confocal microscope such as is shown by way of example in FIG. 1 to scan with light the exhibited region of the wafer surface 21 with the topographic structures 31, 33, and to detect the light returning from the focal point in the focal plane of the objective, measured data being obtained from the position of the focal point and the detected returning light. In this case, the entire structures 31, 33 including regions 35 of the structures 31, 33 whose surface runs parallel to the optical axis, were detected.

The method according to the invention functions particularly effectively when the steep surfaces exhibit a high degree of roughness such that much light is retroreflected from the focal point into the objective and can be detected. However, it is also possible to measure the topographic structures by detecting fluorescence light from the focal point. The structures of the wafer surface can be covered to this end with the fluorescing material, for example. The topographic structures can then likewise be reconstructed from a reconstruction of the fluorescing material. Thus, the underside of the reconstruction, shown in FIG. 3, of the varnish layer constitutes an image of the surface of the wafer.

A further example is shown in FIG. 7 with measured values that are recorded along a section through a wafer having an etched via 31. In a way similar to the exemplary embodiment shown with the aid of FIGS. 4 to 6, the via was also etched here up to an etching stop layer such that the via has a flat bottom region 34. The via 31 further has a back etching. This results in a protruding region 39 of the wafer surface 21. If, for the purpose of measurement, the wafer is arranged in the usual way such that its surface 21 is perpendicular to the optical axis of the objective of the confocal microscope, the region 39 shades regions 37 of the surface of the via 31 with reference to a light that is incident along a direction 41 parallel to the optical axis of the objective. These regions 37 are therefore covered when viewed from the direction of the microscope. As is to be seen with the aid of FIG. 7, however, the entire surface of the structure 31 including the covered or shaded regions 37 is detected according to the invention because of the large numerical aperture of the microscope. The method according to the invention therefore also enables such three-dimensional topographic structures to be completely measured, reconstructed and visualized without being destroyed.

### LIST OF REFERENCE SYMBOLS

1 Confocal microscope
2 Wafer
5 Laser
7 Photomultiplier tube
8 Dichroic mirror
8′ Beam splitter
9, 11 Confocally arranged diaphragms
13 Scanning unit
15 Objective
16 Optical axis of 15
17 Focal point
19 Focal plane
21 Surface of 2
22 Topographic structure
25 Computer
27, 29 Lines
30 Varnish layer
31 Depression
33 Trenches
34 Flat bottom region of 31, 33
35 Vertical surface region
37 Shaded region
39 Shaded region
41 Direction parallel to 16
K Edge
F Flank

1. A method for measuring three-dimensional topographic structures (22) on wafers (2) or devices, the method comprising:
scanning, with the aid of a confocal microscope (1), a varnish layer (30) with excitation light;
detecting the fluorescence light emitted from the focal point (17) in the focal plane (19) of the objective (15) of the microscope (1) and excited by the excitation light;
obtaining measured data from three-dimensionally distributed measuring points from the position of the focal point (17) and the detected fluorescence signal;
calculating a three-dimensional reconstruction of the varnish layer (30) therefrom; and
determining the thickness of the varnish layer (30) from the measured data.

2. The method as claimed in claim 1, wherein at least one of reflected excitation light and scattered excitation light is detected.

3. (canceled)

4. The method as claimed in claim 1, wherein the topographic structure is scanned along the focal plane (19) of the microscope (1) in layerwise fashion.

5. The method as claimed in claim 4, wherein the focal plane (19) is displaced along the optical axis (16) of the objective (15) of the confocal microscope (1) relative to the topographic structure (22) for the purpose of scanning the layers.

6. The method as claimed in claim 5, wherein the displacement of the focal plane (19) is performed by displacing the wafer (2) or device.

7. The method as claimed in claim 1, wherein the topographic structure (22) is scanned in layerwise fashion by means of a scanning unit (13) of the microscope (1).

8. The method as claimed in claim 7, wherein the scanning is performed by means of moving scanning mirrors.

9. The method as claimed in claim 7, wherein the scanning is performed by means of one of a Nipkow disk and an acoustooptic deflector.

10. The method as claimed in claim 1, wherein laser light is used as excitation light.

11. The method as claimed in claim 1, further comprising calculating a three-dimensional reconstruction of the topographic structure (22) from the intensity values of the fluorescence light and assigned position values of the focal point.

12. The method as claimed in claim 11, wherein in order to calculate the three-dimensional structure additional use is made of measured data with intensity values of reflected excitation light and assigned position values of the focal point (17).

13. (canceled)

14. The method as claimed in claim 1, wherein ultraviolet light is used as excitation light.

15. The method as claimed in claim 1, wherein light with a wavelength selected from the group consisting of 480 nm, 458 nm and 514 nm is used as excitation light.

16. The method as claimed in claim 1, wherein a three-dimensional topographic structure (22) is measured that has at least one of the substances comprising photoresist, BCB, and photostructurable epoxy.

17. The method as claimed in claim 1, wherein one of an etched via (31), a dicing street (33) and a micromechanical structure is measured.

18. A method for measuring three-dimensional topographic structures (22, 31, 33) on wafers (2) or devices, the method comprising:
scanning, with the aid of a confocal microscope (1), at least one topographic structure (22) with light;
detecting the light returning from the focal point (17) in the focal plane (19) of the objective (15) of the microscope (1); and
obtaining measured data from the position of the focal point (17) and the detected returning light, regions (35, 37) of the structure being covered whose surface runs along a direction (41) parallel to the optical axis, or that are shaded when light is incident parallel to the optical axis of the microscope.

19. The method as claimed in claim 18, wherein measured data are obtained from the light retroreflected at the surface of the structure (22, 31, 35).

20. The method as claimed in claim 18, wherein measured data are generated from fluorescence light generated at the focal point (19).

21. The method as claimed in claim 18, wherein regions (37) of the structure are measured that are shaded by a region (39) of the structure (31), of the wafer (2) or of the device when light is incident parallel to the optical axis (16) of the objective (15).

22. The method as claimed in claim 18, wherein a region (37) shaded when light is incident parallel to the optical axis (16) of the objective (15) is measured that encloses a back etching of an etched structure (31, 33).
